(19) United States
(12) Patent Application Publication
(10) Pub. No.: US 2026/0077750 A1
(43) Pub. Date: Mar. 19, 2026

(54) FRONT AXLE BRAKING IN THE EVENT OF DEGRADATION

(71) Applicant: Continental Automotive Technologies GmbH, Hannover (DE)

(72) Inventor: Aleksandar Stanojkovski, Kleinostheim (DE)

(73) Assignee: Continental Automotive Technologies GmbH, Hannover (DE)

(21) Appl. No.: 19/330,445

(22) Filed: Sep. 16, 2025

(30) Foreign Application Priority Data
Sep. 16, 2024 (DE) 10 2024 208 791.2

(51) Int. Cl. B60T 8/1766; B60T 13/68

(52) U.S. Cl. CPC B60T 8/1766; B60T 13/686

(57) ABSTRACT

A method for controlling a hydraulic motor vehicle braking system, wherein brake pressure is to be built up at wheel brakes on a front axle and a rear axle by means of via an electric pressure supply device based on a brake demand variable. Inlet valves of the wheel brakes on the front axle and rear axle are open and a brake demand variable is implemented by joint pressure build-up on the front axle and rear axle in the case of no fault. In the event of a fault with a degradation of the pressure supply device, the pressure build-up is first applied to the front axle by closing the inlet valves of the wheel brakes of the rear axle before or at the start of volume delivery. When a condition is met, the wheel brakes on the rear axle are activated by opening the inlet valves.

### TECHNICAL FIELD

A method for controlling a hydraulic motor vehicle braking system based on a brake demand variable comprising building brake pressure at wheel brakes on a front axle and a rear axle by means of an electric pressure supply device.

### BACKGROUND

Brake demand can originate from a brake pedal and thus be initiated by the driver, or it can be generated by an assistance system or an autonomous system. In such brake-by-wire braking systems, in the case of no fault, the driver has no hydraulic access to the wheel brakes. Instead, the brake pressure is built up by an electric pressure supply device. If a fault occurs in such systems, corresponding valve circuits connect a brake pedal-coupled master brake cylinder to the wheel brakes and the driver must build up the brake pressure without assistance using muscle power. However, this results in much poorer deceleration values.

### SUMMARY

It is therefore the object to achieve the shortest possible braking distance even in the event of a fault.

In the event of a fault with a degradation of the pressure supply device, the brake pressure is first applied to the front axle by closing the inlet valves of the wheel brakes of the rear axle before or at the start of volume delivery by means of the pressure supply device, so that pressure build-up is first implemented via open inlet valves only at the wheel brakes of the front axle, and wherein, if a condition is met, the wheel brakes on the rear axle are activated by opening the inlet valves.

Based on a brake demand variable, setpoints which are each greater than zero in each case are therefore determined for the wheel brakes on the front axle and rear axle. For example, the setpoints may be the same. The brake request value is therefore implemented in such a way that the front axle is supplied first and the rear axle is only supplied with brake fluid from the electric pressure supply device afterwards. The system may remain completely by-wire, i.e. the driver still has no control over the wheel brakes but is only connected to a simulator. The method may be for purely electric brake pedals that do not allow any hydraulic or mechanical intervention in the wheel brakes.

If braking is initiated by the driver, the brake demand variable can comprise a brake pedal travel, a brake pedal force and/or a master brake cylinder pressure. The brake demand variable can also be a variable derived from one or more of these variables, such as a target deceleration of the vehicle. In addition, the brake demand variable may also originate from an assistance function or a virtual driver or motion system and correspond to a variable described above or be an equivalent variable.

In the event of a fault in the braking system, fallback levels are used which, depending on the fault, comprise changes of varying severity and thus restrictions on functionality. One such response to a fault is a degradation of the pressure supply device. This means that the pressure supply device is used with reduced performance characteristics.

The pressure build-up at the front axle means that a higher brake pressure can be built up with the same volume delivered. This makes use of the fact that the relationship between pressure and volume of the medium delivered to the wheel brakes has a falling gradient. This means that the target value can be reached very quickly in the front axle, which already provides high deceleration due to the brake force distribution, which is approximately two-thirds at the front axle.

In an embodiment, the degradation of the pressure supply device comprises power limitation, torque limitation, volume delivery limitation and/or speed limitation.

In an embodiment, in the case of no fault, a first pressure setpoint is determined based on the brake demand and implemented in the wheel brakes of the front axle and the rear axle, and in the event of a fault a second pressure setpoint is determined based on the same brake demand, which is greater than the first pressure setpoint and is only implemented at the wheel brakes of the front axle. The second pressure setpoint can be set so that, during braking on the front axle, it corresponds to the same vehicle deceleration as two-axle braking with the first pressure setpoint. For this purpose, it can be set to 120%–150% of the first pressure value. The rear axle can then be activated when the second pressure value is reached and, while the pressure at the rear axle is increased, the pressure value at the front axle is reduced from the second pressure value to the first pressure value. The final state can then be reached when the front and rear axles are again at the common first pressure value.

In a further embodiment, the degradation is triggered by a fault in a motor position sensor of the pressure supply device, by an excessively low vehicle electrical system voltage or by exceeding a temperature threshold value. A synchronous motor drive requires motor angle information in order to switch the commutation field correctly and achieve the optimum speed, acceleration and maximum pressure. In the event of a faulty motor position sensor, degradation is therefore performed. If the vehicle electrical system voltage is low, the motor cannot be supplied with the maximum current, which also reduces the volume delivery speed. If the motor is overheated, its performance is also degraded to prevent irreversible damage and total failure. This protects motor components such as magnets, coils and bridge drivers from damage due to excessive temperatures. The temperature can be measured by a sensor or calculated from a model.

Temperature-dependent current limitation is also known as "derating". If critical temperature thresholds are exceeded, the current consumption or the current supply to the motor is limited. This results in thermal protection but also poorer performance.

In a further embodiment, the brake pressure is only built up on the front axle when a pressure demand gradient and/or deceleration demand gradient exceeds a threshold value. The pressure demand gradient and/or the deceleration demand gradient correspond(s) to a volume flow that can still be delivered by the electric pressure supply device in the degraded state. This means that, depending on requirements, only the front axle or both axles are used for braking.

In a further embodiment, the condition for switching on the rear axle comprises reaching a pressure limit value and/or the elapsing of a predetermined time period. In a variant, the rear axle can be switched on when 80% of the setpoint is reached at the front axle. If the wheel brakes of the front axle are set to the second pressure setpoint and the pressure limit value is set to this second pressure setpoint, the rear axle can be engaged in such a way that the volume flow through the inlet valves into the wheel brakes of the rear axle exceeds the volume flow delivered by the electric pressure supply device in such a way that the brake pressure of the inlet valves drops due to cross-flows. This can be controlled so that the overall deceleration of the vehicle remains constant.

In a further embodiment, the condition for switching on the rear axle also includes the initiation of ABS control on the front axle. It is thus determined that, due to the coefficient of friction at the front axle, a further increase in brake pressure cannot lead to higher deceleration. The available volume flow of the electric pressure supply device is now directed to the rear axle. Even if different brake pressures are requested at the rear axle and the difference between them is greater than a threshold value, for example 1 bar, the rear axle is activated.

In an embodiment, the pressure supply device is a linear actuator. A linear actuator can not only build up pressure quickly and in a controlled manner, but also reduce it without switching outlet valves, thereby avoiding noise and vibrations.

In a embodiment, the pressure supply device comprises a brushless electric motor. Such a motor is efficient, dynamic and durable.

In an embodiment, the degradation comprises limiting the speed to a speed less than 50% of the nominal speed. This allows the motor to cool down to solve thermal problems. In addition

In a further embodiment, the wheel brakes of the rear axle are activated in such a way that the brake pressure at the front axle does not drop. The inlet valves on the rear axle wheel brakes are, correspondingly, not opened directly to the fully open position. Instead, they are controlled according to a characteristic curve with a coil current such that the volume flow flowing through the inlet valves into the wheel brakes of the rear axle is less than or equal to the volume flow delivered by the electric pressure supply device. This prevents brake fluid from flowing from the wheel brakes on the front axle into the wheel brakes on the rear axle via cross-flows, which would cause the pressure in the wheel brakes on the front axle to drop. However, it may also be provided that, when a pressure reduction is requested at both wheel brakes of the front axle, the inlet valves of the rear axle are opened further in order to implement this pressure reduction.

The object is also achieved by a hydraulic motor vehicle braking system, having a control device that is configured to carry out a method as above.

Further features and potential applications are also derived from the description hereunder of exemplary embodiments and from the drawings. All of the features described and/or pictorially depicted are associated with the subject matter of the embodiments both individually and in any combination, also independently of their combination in the claims or the back-references thereof.

### BRIEF DESCRIPTION OF THE DRAWINGS

FIG. 1 schematically shows a braking system according to an embodiment,

FIG. 2 shows a pV diagram of front axle wheel brakes and rear axle wheel brakes;

### DETAILED DESCRIPTION

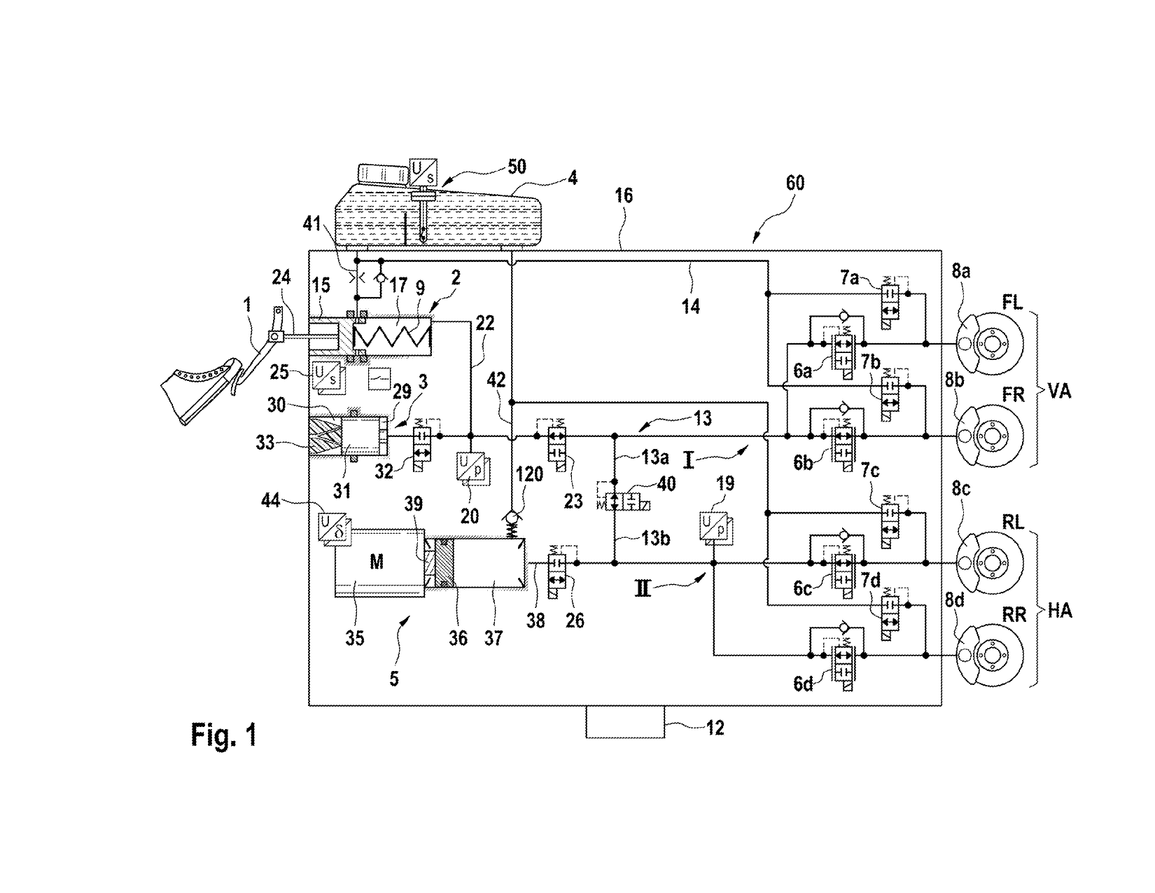

The motor vehicle braking system shown in FIG. 1 comprises four hydraulically actuatable wheel brakes 8a-8d. The braking system comprises a master brake cylinder 2 which is actuatable by means of an actuating pedal or brake pedal 1, a travel simulator or a simulation device 3 which interacts with the master brake cylinder 2, a pressure medium reservoir 4 which is under atmospheric pressure, an electrically controllable pressure supply device 5, and wheel valves, that is to say wheel-specific brake pressure modulation valves which are configured according to the example as inlet valves 6a-6d and outlet valves 7a-7d.

Furthermore, the braking system comprises at least one electronic open-loop and closed-loop control unit 12 for controlling the electrically actuatable components of the braking system. The open-loop and closed-loop control unit 12 has, for example, at least two separate subunits, each of which controls part of the hydraulic units.

According to the example, the wheel brake 8a is assigned to the left front wheel (FL), the wheel brake 8b is assigned to the right front wheel (FR), the wheel brake 8c is assigned to the left rear wheel (RL), and the wheel brake 8d is assigned to the right rear wheel (RR).

The master brake cylinder 2 has, in a housing 16, a master brake cylinder piston 15, which delimits a hydraulic pressure chamber 17, and constitutes a single-circuit master brake cylinder 2. The pressure chamber 17 receives a restoring spring 9 which, with the master brake cylinder 2 unactuated, positions the piston 15 in a starting position. At one end, the pressure chamber 17 is connected to the pressure medium reservoir 4 via radial bores, which are formed in the piston 15, and a corresponding pressure equalization line 41, wherein said bores and line can be shut off by a relative movement of the piston 15 in the housing 16. At the other end, the pressure chamber 17 is connected by means of a hydraulic line section (also referred to as first feed line) 22 to a brake supply line 13 to which the input connections of the inlet valves 6a-6d are connected. The pressure chamber 17 of the master brake cylinder 2 is thus connected to all of the inlet valves 6a-6d.

According to the example, no hydraulic valve, for example no electrically or hydraulically actuatable valve and no non-return valve, is arranged in the pressure equalization line 41 or in the connection between the pressure chamber 17 and the pressure medium storage tank 4.

As an alternative, a normally open, diagnostic valve, for example a connection in parallel between a normally open diagnostic valve and a non-return valve which closes in the direction of the pressure medium reservoir 4, can be contained in the pressure equalization line 41 or between the master brake cylinder 2 and the pressure medium reservoir 4.

An isolating valve 23 is arranged between the feed line 22, which is connected to the pressure chamber 17, and the brake supply line 13, or the pressure chamber 17 is connected to the brake supply line 13 via the first feed line 22 with an isolating valve 23. The isolating valve 23 is designed as an electrically actuatable, preferably normally open (NO), 2/2-way valve. The hydraulic connection between the pressure chamber 17 and the brake supply line 13 can be shut off by the isolating valve 23.

A piston rod 24 couples the pivoting movement of the brake pedal 1 as a result of pedal actuation to the translational movement of the master brake cylinder piston 15, the actuation travel of which is detected by a travel sensor 25 of preferably redundant design. In this way, the corresponding piston travel signal is a measure of the brake pedal actuation angle. It represents a braking request by a vehicle driver and can be used as a brake demand variable.

A pressure sensor 20, which is connected to the first feed line 22, detects the pressure built up in the pressure chamber 17 as a result of a displacement of the piston 15. This pressure value can also be evaluated to characterize or determine the braking request of the vehicle driver and can likewise be used as brake demand variable. As an alternative to a pressure sensor 20, use can also be made of a force sensor 20 for determining the braking request of the vehicle driver.

According to the example, the simulation device 3 is of hydraulic configuration and is hydraulically coupled to the master brake cylinder 2. The simulation device 3 substantially has, for example, a simulator chamber 29, a simulator rear chamber 30 and a simulator piston 31 which separates the two chambers 29, 30 from each other. The simulator piston 31 is supported on a housing by an elastic element 33 (e.g. simulator spring) which is arranged in the simulator rear chamber 30 (which is dry according to the example). According to the example, the hydraulic simulator chamber 29 is connected to the pressure chamber 17 of the master brake cylinder 2 by means of a electrically actuatable, preferably normally closed simulator enable valve 32.

The braking system comprises an inlet valve 6a-6d and an outlet valve 7a-7d for each hydraulically actuatable wheel brake 8a-8d, the inlet valves and outlet valves being hydraulically interconnected in pairs via centre connections and connected to the wheel brake 8a-8d. A non-return valve, not specifically designated, which opens in the direction of the brake supply line 13, is connected in parallel to each of the inlet valves 6a-6d. The output connections of the outlet valves 7a-7d are connected to the pressure medium reservoir 4 via a common return line 14.

The electrically controllable pressure supply device 5 is in the form of a hydraulic cylinder-piston arrangement or a single-circuit, electro-hydraulic actuator or linear actuator, the piston 36 of which is actuatable by an electric motor 35, schematically indicated, with the intermediate connection of a rotary translation transmission 39, likewise schematically illustrated. The piston 36 delimits the single pressure chamber 37 of the pressure supply device 5. A rotor position sensor, merely schematically indicated, which serves to detect the rotor position of the electric motor 35 is denoted by reference sign 44. The electric motor of the linear actuator is designed as a brushless motor and uses the rotor position sensor or motor position sensor 44 for the correct control of the individual motor phases.

A line section (also referred to as second feed line) 38 is connected to the pressure chamber 37 of the electrically controllable pressure supply device 5. The feed line 38 is connected to the brake supply line 13 via an electrically actuatable, normally closed, sequence valve 26. The sequence valve 26 allows the hydraulic connection between the pressure chamber 37 of the electrically controllable pressure supply device 5 and the brake supply line 13 (and thus the input connections of the inlet valves 6a-6d) to be opened and shut off in a controlled manner.

The actuator pressure produced by the action of force of the piston 36 on the pressure medium enclosed in the pressure chamber 37 is fed into the second feed line 38. In a “brake-by-wire” operating mode, for example in a fault-free state of the braking system, the feed line 38 is connected to the brake supply line 13 via the sequence valve 26. In this way, there is, during normal braking, a build up and a reduction in wheel brake pressure for all of the wheel brakes 8a-8d owing to the forward and backward movement of the piston 36. All inlet valves can be open, so that the same brake pressure is built up at the wheel brakes of the front axle and the rear axle together.

In the case of a reduction in pressure by backward movement of the piston 36, the pressure medium previously displaced from the pressure chamber 37 of the pressure supply device 5 into the wheel brakes 8a-8d flows back again into the pressure chamber 37 in the same way.

Alternatively, wheel brake pressures which differ in a wheel-specific way can be simply set by means of the inlet and outlet valves 6a-6d, 7a-7d. In the case of a corresponding reduction in pressure, the portion of pressure medium discharged via the outlet valves 7a-7d flows via the return line 14 into the pressure medium reservoir 4.

Additional pressure medium (“refill”) can be drawn into the pressure chamber 37 owing to a backward movement of the piston 36 with the sequence valve 26 closed by way of pressure medium being able to flow out of the tank 4 into the actuator pressure chamber or pressure chamber 37 via the line 42 with a non-return valve 53, which opens in a flow direction to the actuator 5.

According to the example, the pressure chamber 37 is additionally connected, in an unactuated state of the piston 36, to the pressure medium reservoir 4 via one or more breather holes. This connection between the pressure chamber 37 and pressure medium reservoir 4 is disconnected upon a (sufficient) actuation of the piston 36 in the actuating direction 27.

In the brake supply line 13, an electrically actuatable, normally open circuit isolating valve 40 is arranged, through which the braking system is divided into two hydraulic partial circuits. The brake supply line 13 is divided into a first line section 13a, which is connected (via the isolating valve 23) to the master brake cylinder 2, and a second line section 13b in the second hydraulic partial circuit, which is connected (via the sequence valve 26) to the pressure supply device 5. The first line section 13a is connected to the inlet valves 6a, 6b of the wheel brakes 8a, 8b, and the second line section 13b is connected to the inlet valves 6c, 6d of the wheel brakes 8c, 8d.

With the circuit isolating valve 40 open, the braking system is of single-circuit design. By closing the circuit isolating valve 40, the braking system, in particular controlled according to the situation, can be separated or divided into two hydraulic partial circuits, the brake circuits I and II. Here, in the first brake circuit I, the master brake cylinder 2 is connected (via the isolating valve 23) to only the inlet valves 6a, 6b of the wheel brakes 8a, 8b of the front axle VA, and, in the second brake circuit II, the pressure supply device 5 is connected (with the sequence valve 26 open) to only the wheel brakes 8c and 8d of the rear axle HA.

With the circuit isolating valve 40 open, the input connections of all of the inlet valves 6a-6d can be supplied by means of the brake supply line 13 with a pressure which corresponds to the brake pressure which is provided by the pressure supply device 5 in a first operating mode (e.g. “brake-by-wire” operating mode). In a second operating mode (e.g. in a de-energized fallback operating mode), the pressure of the pressure chamber 17 of the master brake cylinder 2 can be applied to the brake supply line 13.

The braking system advantageously comprises a level-measuring device 50 for determining a pressure medium level/filling level in the pressure medium reservoir 4. A situation recognition for circuit separation by means of the circuit isolation valve 40 advantageously occurs via the level-measuring device 50.

According to the example, the hydraulic components and hydraulic units, namely the master brake cylinder 2, the simulation device 3, the pressure-providing device 5, the valves 6a-6d, 7a-7d, 23, 26, 40 and 32 and also the hydraulic connections including the brake supply line 13, are arranged together in a hydraulic open-loop and closed-loop control unit 60 (HCU). The electronic open-loop and closed-loop control unit (control system) 12 is assigned to the hydraulic open-loop and closed-loop control unit 60. The hydraulic and the electronic open-loop and closed-loop control units 60, 12 are preferably configured as one unit (HECU).

The braking system comprises a pressure sensor 19 or system pressure sensor for detecting the pressure provided by the pressure supply device 5. Here, the pressure sensor 19 is arranged downstream of the sequence valve 26, as seen from the pressure chamber 37 of the pressure supply device 5.

The synchronous motor drive of the linear actuator 5 requires motor angle information in order to switch the commutation field correctly and to be able to provide the optimum speed, acceleration and maximum pressure. If the rotor position sensor 44 fails, the linear actuator cannot maintain synchronous operation reliably. It is therefore degraded, wherein the commutation field is operated at a reduced speed and higher torque without sensed angular position. Instead of the possible 6000 rpm, the motor is limited to 1500 rpm. This means a reduced maximum volume flow that can be provided by the linear actuator.

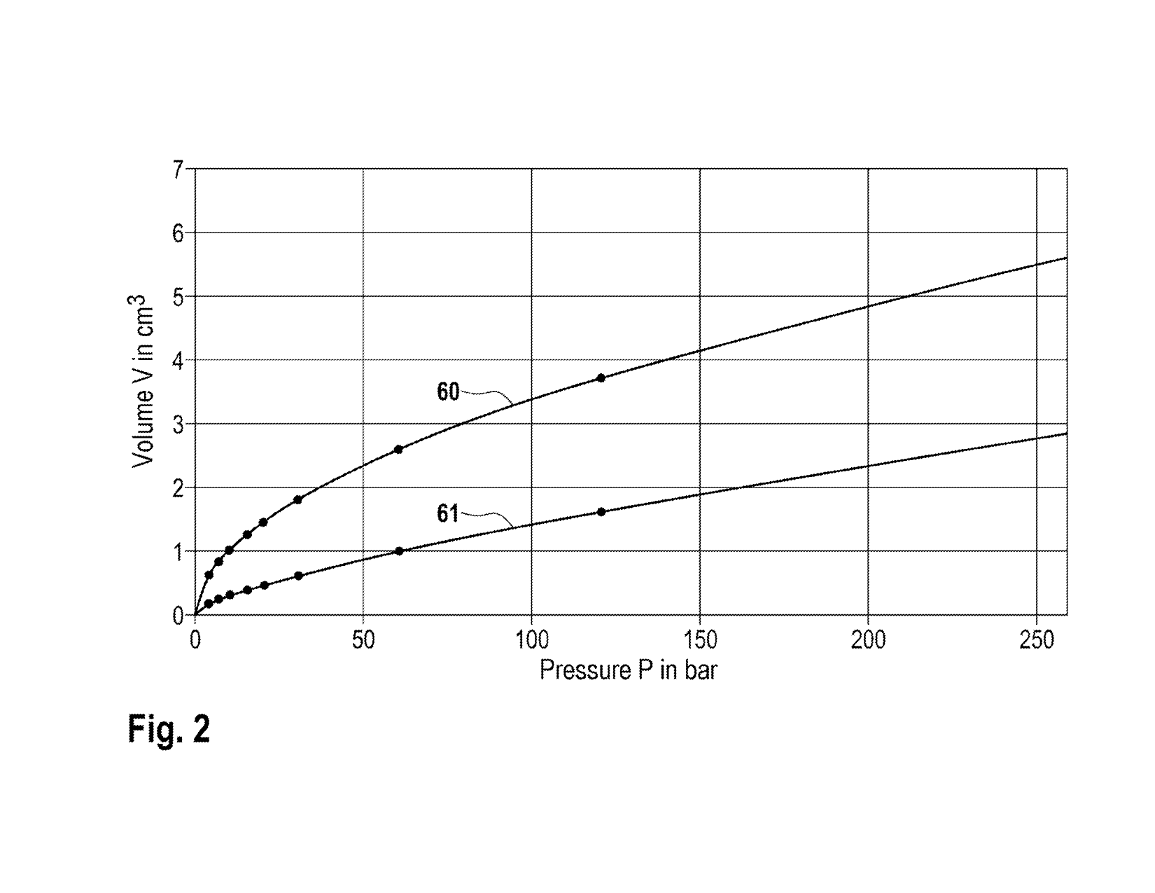

In order to minimize the influence of this degradation on the braking performance, the invention provides for a brake request to be implemented first on the front axle. FIG. 2 shows the volume requirement of wheel brakes on the front axle 60 and on the rear axle 61. It can be seen that even at low pressures, a relatively large volume must be delivered to the wheel brakes. This is due, on the one hand, to the air gap between the brake pads and the brake disc and, on the other hand, to the deflection of the brake pads. At higher pressures, these influencing factors are substantially eliminated, so that a further increase in pressure can be achieved with comparatively less brake fluid volume.

In a comparison, the vehicle deceleration dynamics of 100 bar on both axles are compared with front axle braking of 150 bar. It is assumed that the braking power has an axle distribution of 66/34 (66% is applied to the front axle), meaning that front axle braking of 150 bar is equivalent to 100 bar on both axles. Reading the corresponding volume requirement from FIG. 2, with two front wheel brakes and two rear wheel brakes, results in a volume requirement of 10cm³. The volume requirement for front axle braking of 150 bar, which, as explained above, results in approximately the same vehicle deceleration, is only 8cm³. Neglecting the acceleration phase of the engine, the target deceleration is thus achieved 20% faster using the method according to the invention.

As soon as the front axle brakes have reached the setpoint, the inlet valves 6c, 6d on the rear axle are activated to open in order to achieve the ideal brake force distribution. These are supplied with an electric current which regulates a volume flow that is greater than the volume flow of the linear actuator. This creates a cross flow from the wheel brakes on the front axle to the wheel brakes on the rear axle, which reduces the pressure in the wheel brakes on the front axle. The inlet valves of the rear wheel brakes are controlled in such a way that the pressure reduction at the front axle and the pressure build-up at the rear axle add up to a constant vehicle deceleration.

1. A method for controlling a hydraulic motor vehicle braking system comprising:
implementing a common pressure build-up at wheel brakes of a front axle and rear axle with an electrical pressure supply device based on a brake demand variable via open inlet valves of the wheel brakes on the front axle and rear axle in the case of no fault;
closing the inlet valves of the wheel brakes of the rear axle before or at the start of volume delivery via the pressure supply device so that pressure build-up is first implemented via open inlet valves only at the wheel brakes of the front axle in the event of a fault with a degradation of the pressure supply device; and
opening the inlet valves at the wheel brakes on the rear axle when a condition is present.

2. The method as claimed in claim 1, wherein the degradation of the pressure supply device comprises power limitation, torque limitation, volume delivery limitation and/or speed limitation.

3. The method as claimed in claim 1, further comprising:
determining a first pressure setpoint based on the brake demand in a fault-free case;
implementing the first pressure set point in the wheel brakes of the front axle and the rear axle;
determining a second pressure setpoint based on the brake demand in the event of a fault, wherein the second pressure setpoint is greater than the first pressure setpoint; and
implementing the second pressure setpoint only at the wheel brakes of the front axle.

4. The method as claimed in claim 1, wherein the degradation is triggered by one of: a fault in an engine position sensor of the pressure supply device, a vehicle electrical system voltage that is below a voltage threshold, and exceeding a temperature threshold value.

5. The method as claimed claim 1, wherein the brake pressure is only built up at the front axle initially when a pressure demand gradient and/or deceleration demand gradient exceeds a threshold value.

6. The method as claimed claim 1, wherein the condition for switching on the rear axle comprises at least one of reaching a pressure limit value and the elapsing of a predetermined time period.

7. The method as claimed claim 6, wherein the condition for switching on the rear axle further comprises at least one of the occurrence of ABS control and various requirements on the rear axle wheel brakes on the front axle.

8. The method as claimed claim 1, wherein the pressure supply device is a linear actuator.

9. The method as claimed claim 1, wherein the pressure supply device comprises a brushless electric motor.

10. The method as claimed claim 1, wherein the degradation of the speed is less than 50% of the nominal speed.

11. The method as claimed claim 1, wherein the wheel brakes of the rear axle are activated such that the brake pressure on the front axle does not drop.

12. A hydraulic motor vehicle braking system comprising:
wheel brakes at a front axle of the vehicle;
wheel brakes at a rear axle of the vehicle;
an electrical pressure supply device to build-up pressure at the wheel brakes; and
a control device with instructions for:
implementing a common pressure build-up at the wheel brakes of the front axle and rear axle with the electrical pressure supply device based on a brake demand variable via open inlet valves of the wheel brakes on the front axle and rear axle in the case of no fault;
closing the inlet valves of the wheel brakes of the rear axle before or at the start of volume delivery via the pressure supply device so that pressure build-up is first implemented via open inlet valves only at the wheel brakes of the front axle in the event of a fault with a degradation of the pressure supply device; and
opening the inlet valves at the wheel brakes on the rear axle when a condition is present.
